(19) United States
(12) Patent Application Publication
(10) Pub. No.: US 2005/0025924 A1
(43) Pub. Date: Feb. 3, 2005

(54) Label sheet with protective film

(76) Inventor: Yayoi Toyama, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 10/627,741

(22) Filed: Jul. 28, 2003

(51) Int. Cl. B32B 9/00

(52) U.S. Cl. 428/40.1

(57) ABSTRACT

A label sheet with a protective film includes a printing sheet having a printed side on which information is printed by a printer, the printed information being visible at a backside of the label sheet, a transparent or semi-transparent adhesive layer formed on a side of the printing sheet opposite the printed side so as to be separable, a transparent or semi-transparent protective film placed on the adhesive layer, and a looped cut line formed in the printing sheet so as to encircle a predetermined region of the information reversely printed on the printed side of the printing sheet. The information includes a peripheral region other than the predetermined region. The peripheral region is separated along the looped cut line such that the adhesive layer is exposed.

### BACKGROUND OF THE INVENTION

1. Field of the Invention

The present invention relates to a label sheet with a protective film, for forming-a label having a surface covered with a protective film.

2. Description of the related art

Various types of labels have conventionally been applied to articles including stationary, cellular phones, storage or preserving vessels, laboratory ware, etc., for example. A label sheet from which a label is obtained comprises a printing sheet having a printed side on which information is printed by a printer, an adhesive layer stacked on a backside of the printed side of the printing sheet, and a separable sheet stacked so as to cover the adhesive layer. Thus, the label sheet has a three-layer structure. A looped cut line is formed in the printing sheet and adhesive layer so that the printing sheet and adhesive layer are separable from the separable sheet. In use of the label sheet, information is printed on a label portion of the label sheet by a printer. The label portion is separated from the separable sheet and applied to an article.

A transparent protective film is sometimes used to cover the surface of the label in order that the surface of the label may be protected against water, scratch, stain, etc. After a label has been applied to an article, a protective film is conventionally separated from a protective film sheet discrete from the label sheet. The protective film is applied to the surface of the label.

However, positioning the afore said protective film relative to the label is troublesome. Furthermore, the surface of the label is creased when air enters a space between the protective film and the label. Thus, the protective film is inconvenient in its use. Additionally, the production cost of the label is increased since the protective sheet is manufactured separately from the label sheet.

### SUMMARY OF THE INVENTION

Therefore, an object of the present invention is to provide a label sheet with a protective film, from which a label having a surface covered with a protective film can readily be achieved and which has a low production cost.

The present invention provides a label sheet with a protective film, comprising a printing sheet having a printed side on which information is printed by a printer, the printed information being visible at a backside of the label sheet, a transparent or semi-transparent adhesive layer formed on a side of the printing sheet opposite the printed side so as to be separable, and a transparent or semi-transparent protective film placed on the adhesive layer. A looped cut line is provided in the printing sheet so as to encircle a predetermined region of the information reversely printed on the printed side of the printing sheet. The information includes a peripheral region other than the predetermined region. The peripheral region is separated along the looped cut line such that the adhesive layer is exposed.

In order that the information printed on the printing sheet may be visible at the backside of the label sheet, the printing sheet may be transparent or semi-transparent. Furthermore, the printing sheet maybe a back print film. Printed ink penetrates into the printing sheet such that the ink is visible at the backside even when the printing sheet is opaque.

The protective film may be colored or its surface may be treated such as by matt finish as far as the printed information can be viewed through the protective film. Furthermore, when the protective film has a low ultraviolet transmission, the printed ink can be prevented from fading.

In the above-described label sheet, the looped cut line divides the printing sheet into the predetermined region encircled by the looped cut line and the other peripheral region. When the peripheral region is separated from the adhesive layer, the predetermined region remains on the protective film side. As a result, a label with the peripheral adhesive layer being exposed is formed. The exposed adhesive layer is pressed against the article such that the label is applied to the article.

The printed side of the label faces the article when the label is applied to the article by pressing the exposed peripheral adhesive layer against the article as described above. Accordingly, the backside of the sheet is viewed through the protective film and the adhesive layer. In the foregoing label sheet of the invention, the printed information is visible at the backside of the sheet and accordingly, normal printed information can be viewed through the protective film and the adhesive layer at the backside when the information is reversely printed on the printing sheet. Moreover, since the protective film is provided on the adhesive layer further formed on the backside of the printing sheet, the surface of the label is covered with the protective film when the exposed adhesive layer is pressed against the article so that the label is applied to the article.

Thus, in the invention, information is reversely printed on the printing sheet and the region of the sheet other than the predetermined region is separated. The resultant exposed adhesive layer is pressed against the article so that the label is applied to the article. Consequently, the label having a surface covered with the protective film can readily be obtained. Furthermore, since the printing sheet also serves as the conventional separable sheet, the production cost of the label sheet of the invention can be reduced as compared with the conventional label in which the label sheet and the separable sheet are manufactured individually. Additionally, the label sheet of the invention is good for environment since an amount of separable sheet disposed of or waste can be reduced.

In a preferred form, the label sheet further comprises a looped surface cut line provided in the protective film and the adhesive layer so as to encircle a region which is located outside the looped cut line encircling the predetermined region and is larger than the predetermined region. Consequently, a plurality of labels with respective protective films can be obtained from a single label sheet. More specifically, after information is reversely printed on the predetermined region of the printing sheet, the region of the printing sheet encircled by the surface cut line is cut from the other region so as to be separated from the label sheet. In this case, the predetermined region encircled by the looped cut line or the label is separated from the region other than the label, remaining on the protective film side. In other words, labels remain on the backside of the separated protective film, and the adhesive layer is exposed on the peripheral portion of each label. Accordingly, the exposed face of the adhesive layer is pressed against the article so that the label is applied to the article. Consequently, the label having a surface covered with the protective film can be obtained.

The printed information sometimes extends over the surface cut line in the printing sheet. In this case, the ink serves as a bridge connecting the predetermined region and the peripheral region. Consequently, the looped cut line cannot be cut off desirably depending on the quality of the ink. In view of this problem, another preferred form provides the label sheet with a protective film further comprising a back cut line provided in the peripheral region of the printing sheet so as to be continuous from the looped cut line and so as to extend from near both ends of a portion of the looped cut line formed in a direction substantially perpendicular to a direction in which the peripheral region is mainly separated, the back cut line extending substantially along the direction in which the peripheral region is mainly separated.

In the above-described label sheet, a part of the peripheral region in encircled by the back cut line and a part of the looped cut line continues to the back cut line. The part of the peripheral region is separated from the adhesive layer. Since the separation is carried out along the looped cut line (the direction in which the bridge of ink extends), the ink bridge can be cut off easily. Consequently, the ink bridge over the looped cut line formed in the direction substantially perpendicular to the direction in which the peripheral region is mainly separated is completely cut off. Subsequently, the region encircled by the surface cut line is cut off from the other region to be separated from the label sheet. The predetermined region remains on the protective film side. Furthermore, there is sometimes a case where an ink bridge is formed over the looped cut ink formed so as to extend along the direction in which the printing sheet is separated. However, the bridge formed in the portion of the sheet at which the separation is initiated is completely cut off, and the direction in which the sheet is cut off corresponds with the direction in which the protective film is separated. Consequently, the bridge can be cut off readily, that is, the predetermined region can be separated from the peripheral region promptly, remaining on the protective film side.

### BRIEF DESCRIPTION OF THE DRAWINGS

Other objects, features and advantages of the present invention will become clear upon reviewing the following description of embodiments, made with reference to the accompanying drawing, in which:

FIG. 1 is a partially enlarged sectional view of a label sheet in accordance with one embodiment of the present invention;

FIG. 2 is a perspective view of the label sheet;

FIG. 3 is a perspective view of the label sheet with the peripheral region having been separated from the adhesive layer;

FIG. 4 is a perspective view of the label applied to an article;

FIG. 5 is a perspective view of the label sheet in accordance with a second embodiment of the invention;

FIG. 6 is a perspective view of the label sheet with the labels having been separated;

FIG. 7 is a perspective view of the label applied to an article;

FIG. 8 is a perspective view of the label sheet in accordance with a third embodiment of the invention;

FIG. 9 is a partially enlarged sectional view along line A-A in FIG. 8;

FIG. 10 is a perspective view showing the process for separating a partial region;

FIG. 11 is a partially enlarged section of the label sheet as shown in FIG. 10;

FIG. 12 is a perspective view showing the process for separating a label with a protective film from the label sheet;

FIG. 13 is a partially enlarged section of the label sheet as shown in FIG. 11; and

FIG. 14 is a partially enlarged section of the label with the protective film having been separated from the label sheet.

### DETAILED DESCRIPTION OF THE INVENTION

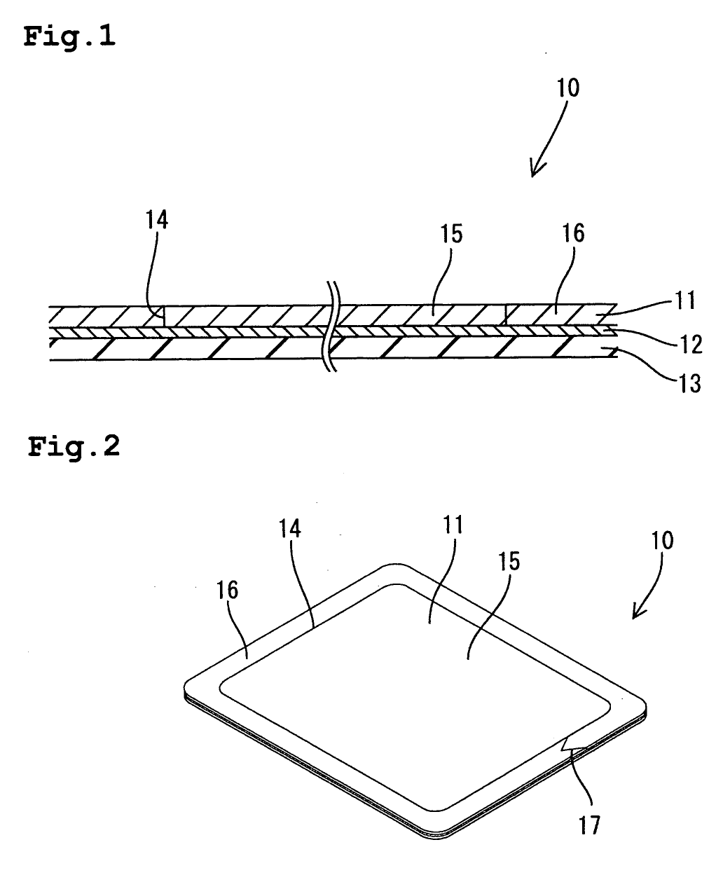

A first embodiment of the present invention will be described with reference to FIGS. 1 to 4. A label sheet 10 of the embodiment is applied to a piece of information put onto a table in a coffee shop, for example. The label sheet 10 comprises an A5 size printing sheet 11 having a printed side on which information can be printed by an ink-jet printer, an adhesive layer 12 placed on a backside of the printed side of the printing sheet 11, and a protective film 13 placed so as to cover the adhesive layer 12, as shown in FIG. 1. Thus, the label sheet 10 has a three-layer structure.

The above-noted printing sheet 11 may be a white back print paper made of a transparent base film (not shown) further made of PET (polyethylene terephthalate). An inkjet coating is applied to the base film so that ink can penetrate the printing sheet. When information is printed on the side opposite the base film, a printing ink penetrates the printing sheet such that information can be viewed at the backside. The printing sheet 11 has a thickness of about 50 □m. The adhesive layer 12 is made of a transparent adhesive agent and has a thickness of about 10 □m. The transparency of the adhesive layer 12 is set so that information printed on the printing sheet 11 can be viewed through the adhesive layer. Whether the adhesive layer is colored and what level of transparency the adhesive layer has does not matter. Furthermore, the protective film 13 is transparent and is made of PET. The protective film 13 has a thickness of about 40 □m. A separating agent (not shown) is applied between the printing sheet 11 and the adhesive layer 12.

A looped seam or cut line 14 is formed in the printing sheet 11 so as to be about 5 mm inwardly away from the end of the sheet as shown in FIGS. 1 and 2. A part of label 15 encircled by the looped cut line 14 and a peripheral region 16 other than the label are separable from each other by the looped cut line. The peripheral region 16 serves as a predetermined region in the invention. A part of the peripheral region 16 is formed with a notch 17 extending from the end of the printing sheet 11 to the looped cut line 14 as shown in FIG. 2.

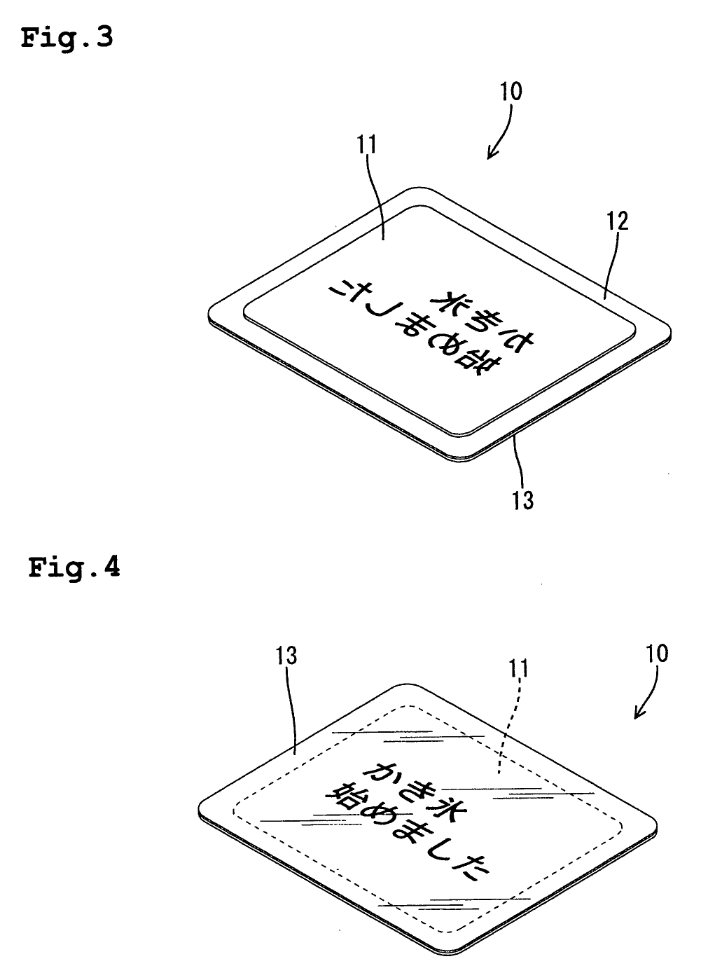

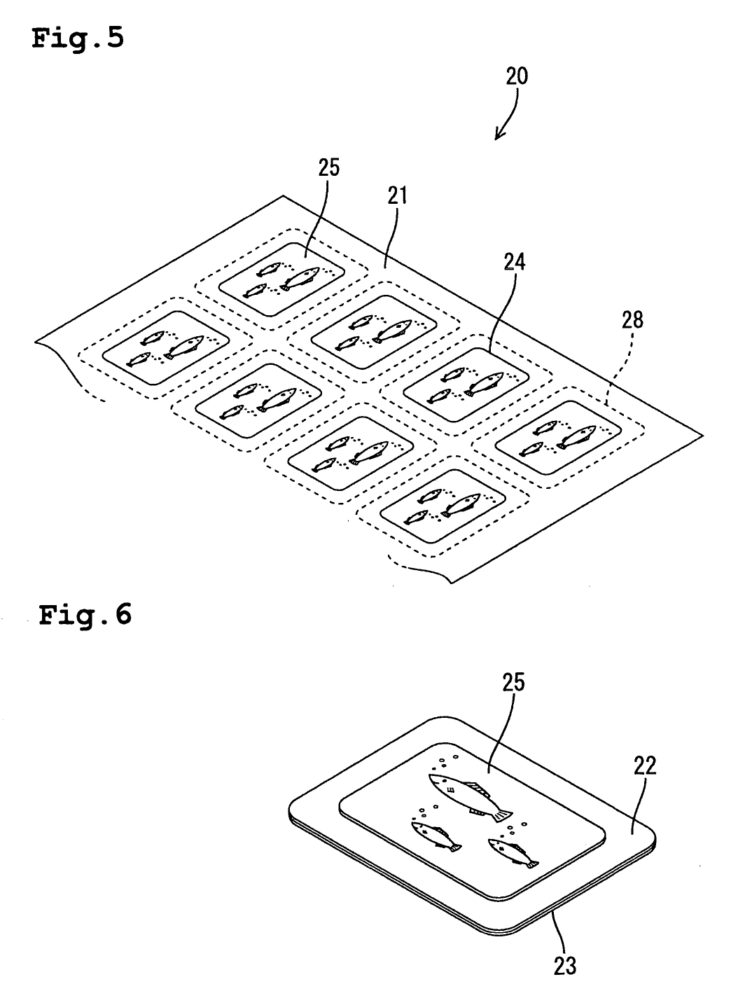

When the above-described label sheet 10 is used, information is reversely printed on the printed side of the printing sheet 11 by a printer or the like so as to be inside out. An end of the notch 17 is held with fingers so that the peripheral region 16 of the sheet 11 is separated from the adhesive layer 12. As a result, the adhesive layer around the label 15 is exposed (see FIG. 3). The label sheet 10 is reversed so that the protective film 13 is an upper side. The exposed side of the underside or adhesive layer 12 is placed on a table and pressed from above, whereupon the label 15 is applied to the table.

According to the above-described label sheet 10, the information is reversely printed on the printing sheet 11. The peripheral region 16 is separated such that the exposed adhesive layer 12 is applied to the table. Consequently, the label 15 having a surface covered with the protective film 13 is readily obtained.

The label sheet 20 of a second embodiment also has a three-layer structure as in the first embodiment. The label sheet 20 includes a printing sheet 21 in which a plurality of rectangular looped seams or cut lines 24 are formed. The label sheet 20 further includes an adhesive layer 22 and a protective film 23 in both of which a surface seam or cut line 28 is formed. The surface cut line 28 is outwardly away from the looped cut lines 24 by about 3 mm and has a rectangular shape. The surface cut line 28 is larger than the looped cut lines 24. The label sheet 20 of A5 side is formed with eight protective films 23 and labels 25, for example.

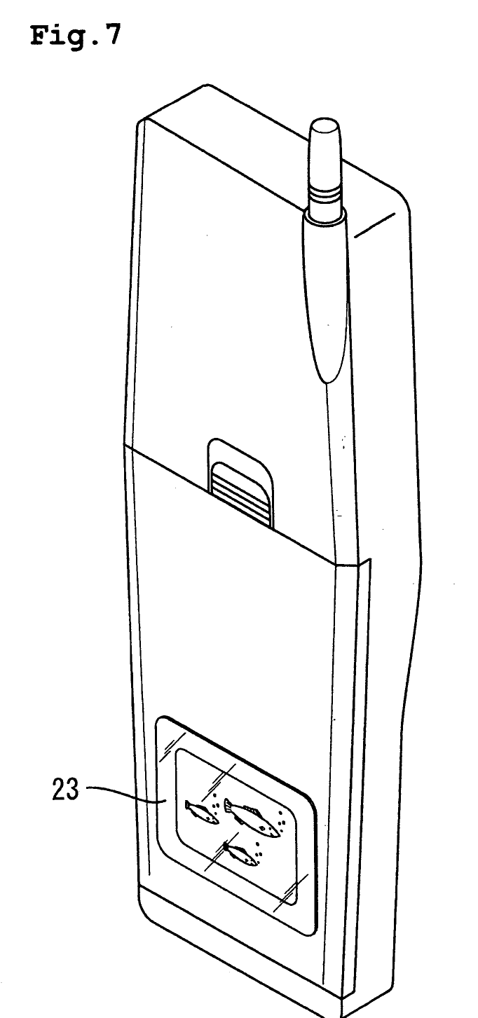

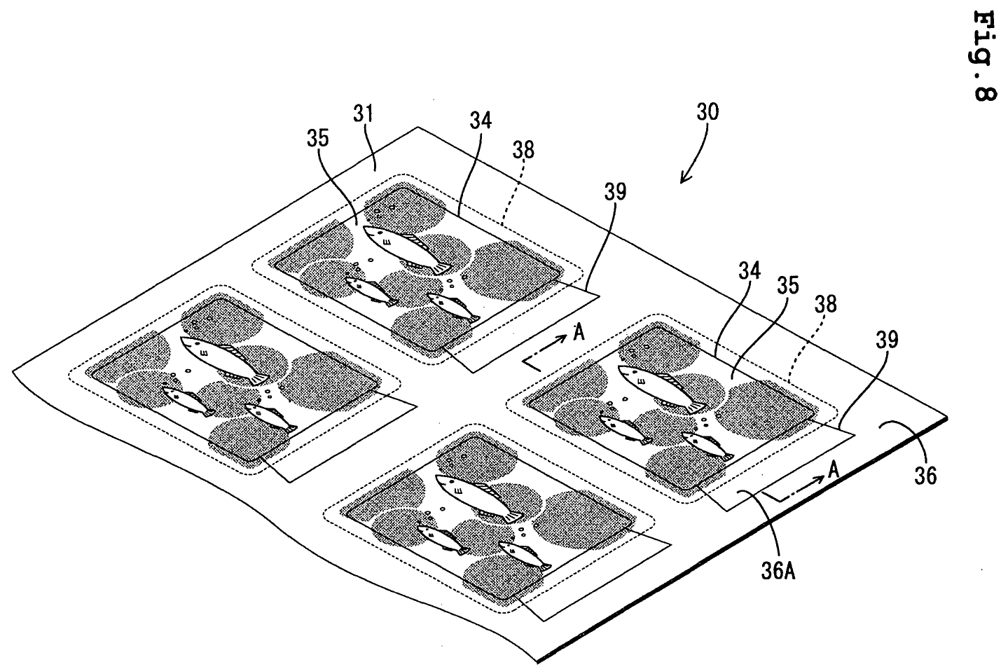

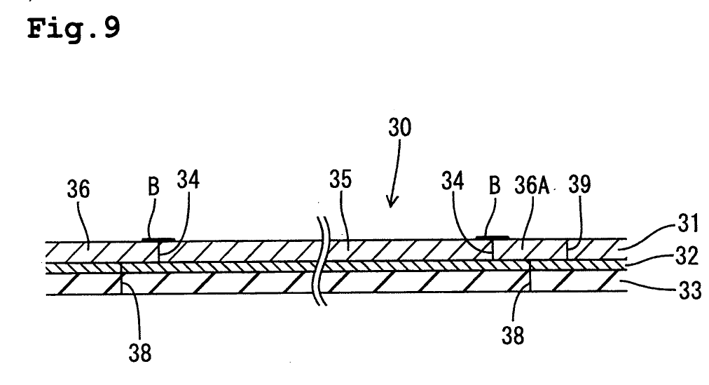

When the label sheet 20 is used, information is reversely printed on the printed side of the printing sheet 21 by a printer or the like so as to be inside out, in the same manner as in the first embodiment. The label sheet 20 is then reversed, and an end of the surface cut line 28 is held with fingers so that the adhesive layer 22 and the protective film 23 are partially cut off from the other region in the stacked state so as to be separated from the label sheet. In this case, since the looped cut lines 24 is formed inside the surface cut line 28 in the printing sheet 21, the region of sheet 21 encircled by the looped cut line 24 or the label 25 is cut off from the other peripheral region, whereupon the label 25 remains stacked on the backside of the protective film 23 to be separated. Consequently, the adhesive layer 22 is exposed on the peripheral portion of the backside of the protective film 23, as shown in FIG. 6, and the part of the label 25 remains. Thereafter, as shown in FIG. 7, the exposed adhesive layer 22 is applied to a cellular phone, and the label 25 is applied to the phone together with the protective film 23.

According to the above-described label sheet 20, a plurality of labels with respective protective films can be obtained in addition to the same effects as described in the first embodiment.

The label sheet 30 of a third embodiment also has a three-layer structure as in the foregoing embodiments. The label sheet 30 includes a printing sheet 31 in which a plurality of rectangular looped seams or cut lines 34 are formed. The label sheet 30 further includes an adhesive layer 32 and a protective film 33 in both of which a surface seam or cut line 38 is formed. Furthermore, a back cut line 39 is formed in the printing sheet 31. The back cut line 39 is formed in a linear shape so as to slightly spread from both ends of one of two short sides of the label 35 (that is, the looped cut line 34) toward the edge of the label sheet 30. The back cut line 39 is closed so as to be parallel to the short side of the label 35 (the looped cut line 34). Thus, the back cut line 39 forms a trapezoidal region 36A having, as a side, the looped cut line 34.

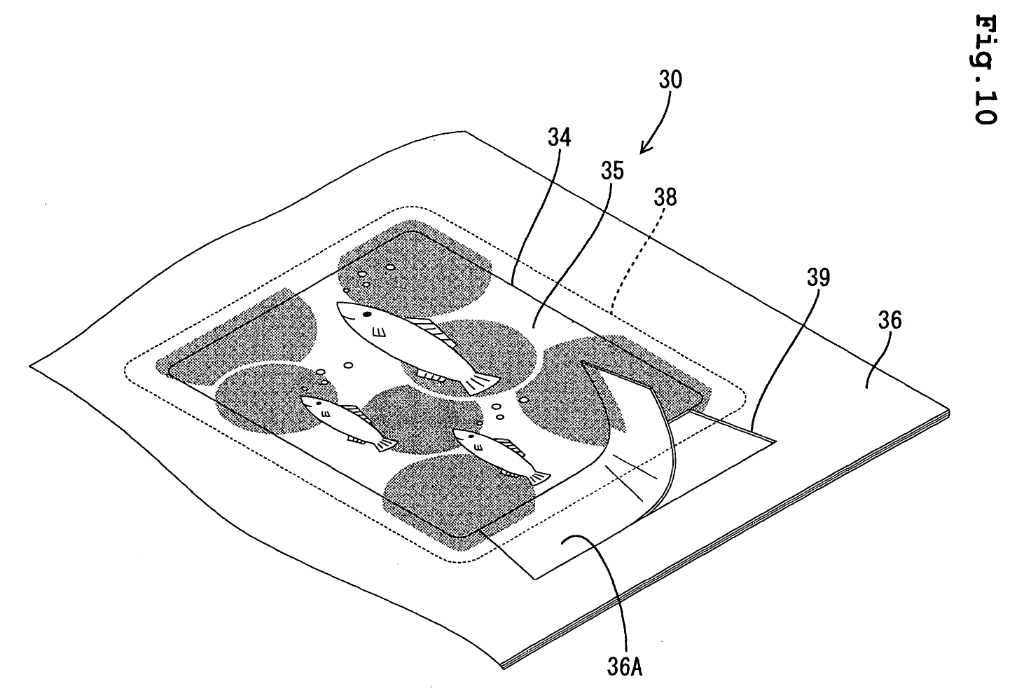

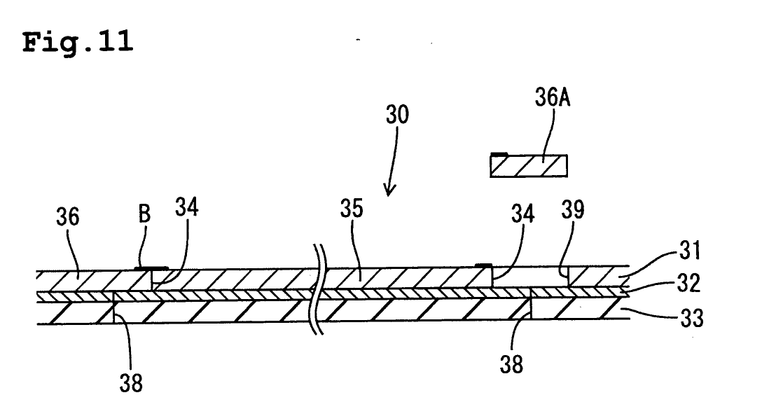

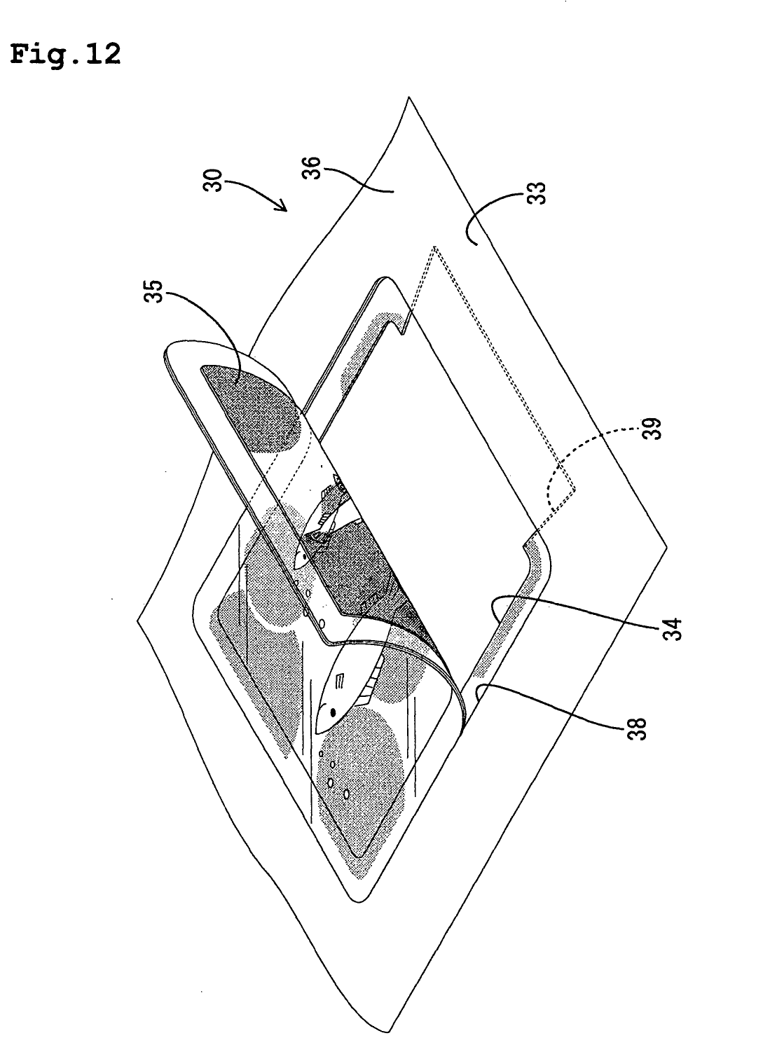

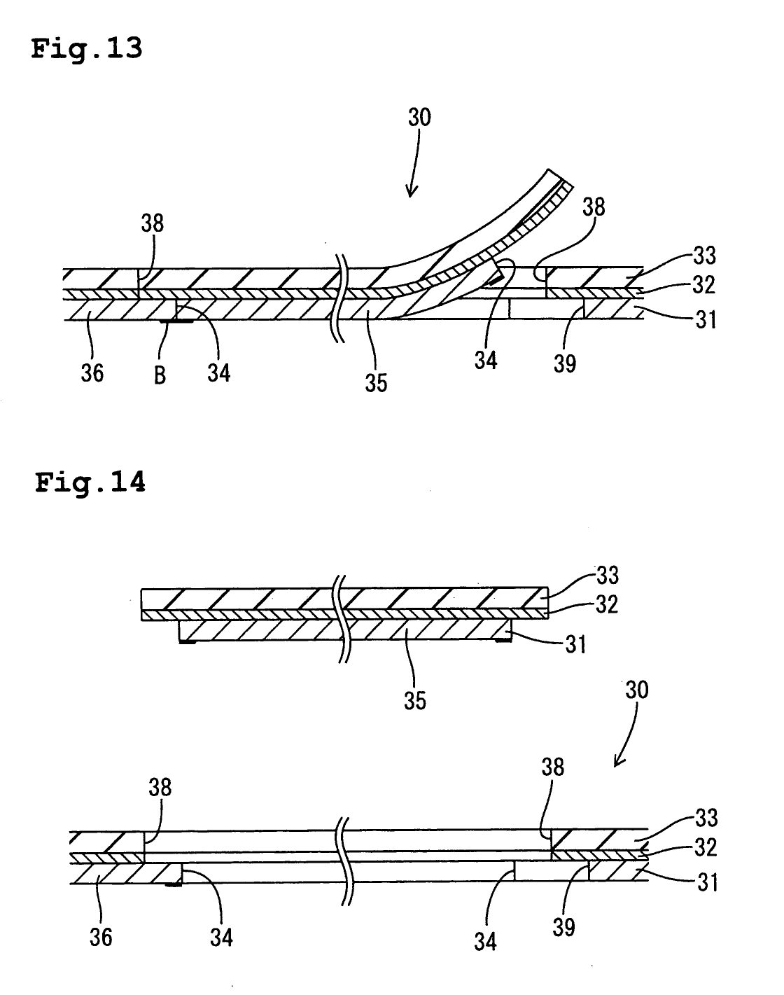

When the label sheet 30 is used, information is reversely printed on the printed side of the printing sheet 31, and thereafter, an acute portion of the trapezoidal region 36A is held with fingers so that the trapezoidal region is separated from the label sheet 30 along the looped cut line 34 (see FIGS. 10 and 11). In this case, a bridge B caused by printing ink sometimes extends over the cut portion of the looped cut line 34. However, since the region 36A is separated along a direction in which the bridge B is formed, the looped cut line 34 can be cut off easily. The label sheet 30 is then reversed, and an end of the surface cut line 38 is held with fingers so that the protective film 33 and the adhesive layer 32 are partially cut off from the other region to be separated from the label sheet 30 (see FIGS. 12 to 14). In this case, the ink bridge B extending over the short side of the looped cut line 34 is completely cut as described above. Accordingly, the end of the label 35 at which separation starts remains on he protective film 33 side. Furthermore, the ink bridge B is sometimes formed over a long side of the looped cut line 34. However, the bridge B is easily cut along the direction of separation due to the previously cut portion of the looped cut line 34. Consequently, the label 35 is completely cut off from the peripheral region 36 such that the overall label remains on the protective film 33 side.

According to the above-described label sheet 30, the separating work can be simplified in addition to the effects achieved by the first and second embodiments.

In the above-described second embodiment, the looped cut line 24 and surface cut line 28 have the same shape and sizes differing from each other. However, the looped cut line 24 and surface cut line 28 may or may not have the same shape. The surface cut line 28 may be formed so that the adhesive layer 22 is exposed on only a part of the outer peripheral edge of the label 25, or the width of the exposed portion of the adhesive layer 22 may differ from one location to another.

In the above-described third embodiment, the back cut line 39 forms the trapezoid together with the looped cut line 34. For example, the back cut line 39 may form a triangular shape, or a mere notch may be formed. Thus, any arrangement may be employed for cutting off the ink bridge formed on the looped cut line 34.

The foregoing description and drawings are merely illustrative of the principles of the present invention and are not to be construed in a limiting sense various changes and modifications will become apparent to those of ordinary skill in the art. All such changes and modifications are seen to fall within the scope of the invention as defined by the appended claims.

1. A label sheet with a protective film, comprising:
a printing sheet having a printed side on which information is printed by a printer, the printed information being visible at a backside of the label sheet;
a transparent or semi-transparent adhesive layer formed on a side of the printing sheet opposite the printed side so as to be separable;
a transparent or semi-transparent protective film placed on the adhesive layer; and
a looped cut line provided in the printing sheet so as to encircle a predetermined region of the information reversely printed on the printed side of the printing sheet, the information including a peripheral region other than the predetermined region, the peripheral region being separated along the looped cut line such that the adhesive layer is exposed.

2. A label sheet with a protective film according to claim 1, further comprising a looped surface cut line provided in the protective film and the adhesive layer so as to encircle a region which is located outside the looped cut line encircling the predetermined region and is larger than the predetermined region.

3. A label sheet with a protective film according to claim 2, further comprising a back cut line provided in the peripheral region of the printing sheet so as to be continuous from the looped cut line and so as to extend from near both ends of a portion of the looped cut line formed in a direction substantially perpendicular to a direction in which the peripheral region is mainly separated, the back cut line extending substantially along the direction in which the peripheral region is mainly separated.
